(19) United States
(12) Patent Application Publication
(10) Pub. No.: US 2021/0017048 A1
(43) Pub. Date: Jan. 21, 2021

(54) SOLAR THERMAL MEMBRANE DISTILLATION SYSTEM FOR DRINKING WATER PRODUCTION

(71) Applicant: Florida Atlantic University Board of Trustees, Boca Raton, FL (US)

(72) Inventors: Peng Yi, Boca Raton, FL (US); Rahamat Ullah Tanvir, Columbia, MO (US); Shahin Ahmed Sujon, Boca Raton, FL (US)

(21) Appl. No.: 17/034,866

(22) Filed: Sep. 28, 2020

Related U.S. Application Data
(63) Continuation-in-part of application No. PCT/US2019/022233, filed on Mar. 14, 2019.
(60) Provisional application No. 62/649,287, filed on Mar. 28, 2018.

(51) Int. Cl. C02F 1/44; B01D 61/36; B01D 69/02; B01D 67/00; B01D 71/34; B01D 71/02; C02F 1/14

(52) U.S. Cl. CPC C02F 1/447; B01D 61/364; B01D 61/366; B01D 69/02; C02F 2103/08; B01D 71/34; B01D 71/021; C02F 1/14; B01D 67/0088

(57) ABSTRACT

A solar distillation device includes a feed water chamber having an open interior feed water compartment and a feed water inlet to the feed water compartment. A distillate chamber has a top and sides and an open interior distillate compartment, and a distillate water outlet in liquid communication with the distillate compartment. The top, the rear wall, and the sides of the distillate chamber includes a solar radiation transmissive portion. A distillation membrane separates the feed water compartment from the distillate compartment, and has a feed water facing surface and a distillate facing surface. The membrane can include a porous hydrophobic material, and the distillate surface of the distillation membrane can be black. The transmissive portion allows solar radiation to pass through the top, the rear wall, and the sides of the distillate chamber and strike the distillation membrane.

### CROSS-REFERENCE TO RELATED APPLICATIONS

This application is a Continuation-In-Part of International Patent Application No. PCT/US2019/22233 filed on Mar. 14, 2019, which claims priority to U.S. provisional application Ser. No. 62/649,287 filed on Mar. 28, 2018, entitled “A NOVEL SOLAR THERMAL MEMBRANE DISTILLATION SYSTEM FOR DRINKING WATER PRODUCTION IN UNDERDEVELOPED AREAS”, the entire disclosures of which are hereby incorporated herein by reference.

### FIELD OF THE INVENTION

The present invention relates to water purification, and more particularly to water purification by distillation.

### BACKGROUND OF THE INVENTION

Drinking water is considered one of the most essential human needs. Unfortunately, one in three people on the earth is affected by a scarcity of fresh water. The situation is worse in underdeveloped areas where there is no electricity to power conventional water treatment technologies.

Existing solar water purification systems typically fall in the category of solar membrane distillation systems and solar stills. The conventional solar membrane distillation system consists of many individual devices such as a solar thermal heater for heating the feed water, photovoltaic cells for generating electricity, pumps for circulating the water, pressure valves, and a heat exchanger in some cases. The complexity of these conventional solar membrane distillation systems unavoidably reduces the reliability of the system and raises the capital and maintenance cost. Also, the solar heater and the membrane distillation module are separated in conventional systems, resulting in additional heat loss when feed water is transferred from the solar heater to the membrane distillation module.

The solar still relies exclusively upon distillation for purification and thus requires significant solar energy input, and thus time and solar input, to purify a given amount of feed water. Existing solar stills are black containers in which the water undergoes a natural evaporation process. The black container absorbs solar thermal energy and heats the entire bulk water in the container. The water vapor is then condensed into distilled water. Since the solar still heats the entire bulk feed water, solar stills have low production rates of distilled water per unit area of solar heat absorber.

### SUMMARY OF THE INVENTION

A solar distillation device includes a feed water chamber having an open interior feed water compartment and a feed water inlet to the feed water compartment, and a distillate chamber having a top and sides and an open interior distillate compartment, and a distillate water condensate outlet in liquid communication with the distillate compartment. The top and sides of the distillate chamber include a solar radiation transmissive portion. A distillation membrane separates the feed water compartment from the distillate compartment, and has a feed water facing surface and a distillate facing surface. The membrane includes a porous material. The transmissive portion allows solar radiation to pass through the top and strike the distillation membrane.

The distillate facing surface of the distillation membrane can be black. The membrane materials can be hydrophobic. The solar distillation device can further include a condensing channel communicating with the distillate compartment.

The feed water chamber and the distillate chamber can be detachably connected. A gasket can be provided between edge portions of the feed water facing surface of the membrane and the feed water chamber, and a gasket can be provided between edge portions of the distillate facing surface of the membrane and the distillate chamber.

A condensing chamber can include top, side and bottom portions defining an open interior condensing compartment in liquid communication between the distillate compartment and the distillate outlet. The top and side portions of the condensing chamber can include a solar radiation reflective material.

A support can be provided for maintaining the feed water inlet above a portion of the feed water compartment, and for maintaining a portion of the distillate compartment above the distillate water condensate outlet. Feed water will flow into the feed water compartment under the influence of gravity, and water distillate will flow into the condensate outlet under the influence of gravity.

The distillate facing surface of the membrane can include carbon black particles. The carbon black particles can have a diameter of from 15 nm to 500 nm.

A sediment outlet can be provided and is in communication with the feed water compartment and is below the feed water inlet. A mesh can be provided for retaining the membrane in position.

The solar distillation device can further include a distillate guider for collecting condensate from the side portions of the distillate chamber. The distillate guider can have an upwardly facing channel at interior facing sides of the distillate chamber. The distillate guider collects condensate of distillate vapor in the distillate compartment and directs the distillate water toward the distillate water condensate outlet. The distillate guider can be an upwardly facing c-shaped channel.

The distillation membrane can have pores having a nominal diameter of from 0.02 μm to 200 μm. The thickness of the distillation membrane can be from 5 μm to 500 μm. The distillation membrane can include at least one selected from the group consisting of PVDF, PTFE, PP, PE, PCTE, ECTFE, non-woven polyester, and non-woven polypropylene. A mesh spacer can be provided for restricting the movement and deformation of the distillation membrane.

A method of solar distillation can include the step of providing a solar distillation device comprising a feed water chamber having an open interior feed water compartment and a feed water inlet to the feed water compartment, a distillate chamber having a top and sides and an open interior distillate compartment, and a distillate water condensate outlet in liquid communication with the distillate compartment. The top and sides of the distillate chamber can include a solar radiation transmissive portion. A distillation membrane separates the feed water compartment from the distillate compartment and has a feed water facing surface and a distillate facing surface. The solar radiation transmissive portion allows solar radiation to pass through the top of the distillate chamber and strike the distillation membrane.

A water supply is connected to the feed water inlet so as to cause feed water to flow into the feed water compartment and by hydraulic pressure into pores of the porous membrane, be heated and evaporated, and pass through the distillation membrane into the distillation compartment as water vapor. The water vapor is condensed into distillate and the water distillate is collected from the distillate water condensate outlet.

A method of making a solar distillation device includes the step of providing a feed water chamber having an open interior feed water compartment and a feed water inlet to the feed water compartment, and a distillate chamber having a top and sides and an open interior distillate compartment, and a distillate water outlet in liquid communication with the distillate compartment. The top and sides of the distillate chamber includes a solar radiation transmissive portion. A distillation membrane separates the open interior of the feed water chamber from the open interior of the distillate chamber and has a feed water facing surface and a distillate facing surface. The solar radiation transmissive portion allows solar radiation to pass through the top and strike the distillation membrane. The distillation membrane is positioned between the feed water chamber and the distillate chamber, and the distillate chamber is connected to the feed water chamber.

A solar distillation device can include an enclosed porous distillation membrane assembly comprising a membrane having a plurality of pores and having an open interior providing a feed water compartment, a feed water inlet to the feed water compartment, a sediment outlet, and a black exterior surface portion. An enclosed distillate chamber has a top and sides and an open interior distillate compartment. The distillation membrane assembly is mounted within the distillate chamber. The distillate chamber further includes a condensate outlet in liquid communication with the open interior of the distillate chamber. Portions of the distillate chamber comprise a solar radiation transmissive material, the transmissive portions allowing solar radiation to pass through and strike the distillation membrane. Water in the enclosed feed water compartment will be heated and water vapor will be transmitted through the pores, wherein the water vapor will condense in the distillate chamber as purified water condensate.

The distillation membrane assembly can be tubular. The distillation membrane assembly is a cone. The distillate chamber can be tubular. The distillate chamber can include a cone-shaped portion. The distillate chamber can be box shaped with straight sides. The distillate chamber can include solar reflective portions. The distillate chamber can include thermally insulating portions.

The distillation membrane comprises an interior surface, and portions of the interior surface can include a hydrophobic material, whereby liquid water will be repelled from the pores and water vapor will pass through the pores of the distillation membrane.

The distillation membrane assembly can include a sediment outlet opening. The solar distillation device can further include a sediment collection device positioned to receive sediment from the sediment outlet opening. The sediment collection device can be funnel shaped.

### BRIEF DESCRIPTION OF THE DRAWINGS

There are shown in the drawings embodiments that are presently preferred it being understood that the invention is not limited to the arrangements and instrumentalities shown, wherein:

FIG. 1 is a perspective view of a solar distillation device according to the invention.

FIG. 2 is a side elevation.

FIG. 3 is a plan view.

FIG. 4 is a bottom view.

FIG. 5 is a cross section taken along line 5-5 in FIG. 3.

FIG. 6 is a rear elevation.

FIG. 7 is a cross section taken along line 7-7 in FIG. 6.

FIG. 8 is a cross-section taken along line 5-5 in FIG. 3 and showing schematic operation of the device.

FIG. 9 is an enlargement of area 9 in FIG. 7 and showing schematic operation of the device.

FIG. 10 is a schematic cross-section of a distillation membrane and showing schematic operation of the membrane.

FIG. 11 is a schematic cross-section of a distillation membrane coated with carbon black particles and showing schematic operation of the membrane.

FIG. 12 is a plot of evaporation rate (kg/m² h) of deionized (DI) water contained in a glass beaker and covered by a white membrane, no membrane, and carbon-black coated membranes with different amounts of carbon-black particles as a in the unit of percentage of the mass of original white membrane, under simulated sunlight at an irradiance of 1812 W/m².

FIG. 13 is a plot of the production rate of distilled water per unit area of solar heat absorber (kg/m² h) for DI water, seawater, canal water, and wastewater over an initial 4 hours under simulated sunlight at an irradiance of 1556 W/m².

FIG. 14 is a plot of the production rate of distilled water per unit area of solar heat absorber (kg/m² h) vs. time (days) for seawater, canal water, and wastewater. The system operated 8 hours a day under the simulated sunlight at an irradiance of 1556 W/m².

FIG. 15 is a plot of turbidity (NTU) vs. time (days) for distilled water produced from seawater, canal water and wastewater. The system operated 8 hours a day under the simulated sunlight at an irradiance of 1556 W/m².

FIG. 16 is a plot of electrical conductivity (mS/cm) vs. time (days) for distilled water produced from seawater, canal water, and wastewater. The system operated 8 hours a day under the simulated sunlight at an irradiance of 1556 W/m².

FIG. 17 is a plot of chemical oxygen demand (mg/L) vs. time (days) for distilled water (mg/L) produced from seawater, canal water, and wastewater. The system operated 8 hours a day under the simulated sunlight at an irradiance of 1556 W/m².

FIG. 18 is a graph showing a comparison of production rates of distilled water per unit area of solar heat absorber (L/m² day) for the invention, existing solar stills, and membrane distillation systems under natural sunlight.

FIG. 19 is a schematic perspective view of an alternative embodiment with a tubular membrane.

FIG. 20 is a schematic vertical cross-section of the alternative embodiment.

FIG. 21 is a schematic cross-section taken along line 21-21 in FIG. 20.

FIG. 22 is a schematic perspective view of an alternative embodiment with a conical membrane assembly.

### DETAILED DESCRIPTION OF THE INVENTION

A solar distillation device includes a feed water chamber having an open interior feed water compartment and a feed water inlet to the feed water compartment. A distillate chamber has a top and sides and an open interior distillate compartment, and a distillate water outlet in liquid communication with the distillate compartment. The top and sides of the distillate chamber have a solar radiation transmissive portion. A distillation membrane separates the feed water compartment from the distillate compartment and has a feed water facing surface and a distillate facing surface. The membrane comprises a porous material. Solar radiation striking the transmissive portion passes through the top and sides of the distillate chamber and the distillation compartment, and strikes the distillation membrane. The distillation membrane is heated by the solar radiation, and water pressured into the pores of the membrane by hydraulic force is heated and evaporates into water vapor which moves into the distillate compartment. The water vapor condenses into water exits through a condensed water outlet. The transmissive top can be transparent.

The solar distillation device can further include a condensing compartment communicating with the distillate compartment. The condensing compartment can be formed within a condensing chamber that has a reflective and/or light shielding top surface such that the temperature within the condensing compartment is below that of the distillate compartment. Water vapor entering the condensing compartment is condensed into liquid water droplets by the reduction in temperature. The condensing compartment can have different sizes and shapes. The condensing chamber can include top, side and bottom portions defining an open interior condensing compartment in liquid communication between the distillate compartment and the distillate outlet. The top and side portions of the condensing chamber can have a solar radiation reflective or blocking material. Suitable reflective materials include reflective metal foils and coatings, white or light colored reflective paints or light reflective layers that are adhered to the condensing chamber. The device will operate without a condensing compartment but will operate with improved efficiency with a condensing compartment.

The distillation membrane is microporous. The distillation membrane comprises pores having a diameter of from 0.02 μm to 200 μm. The membrane can be hydrophobic, or coated with a hydrophobic surface coating. The surface tension between the hydrophobic material and water can contain the feed water within the membrane and prevent water penetration through the membrane under hydraulic pressure. The thickness of the distillation membrane can be from 5 μm to 500 μm.

Several different materials are suitable for the distillation membrane. The distillation membrane can be selected from the group consisting of polyvinylidene fluoride (PVDF), polytetrafluoroethylene (PTFE), polypropylene (PP), polyethylene (PE), polycarbonate track etched (PCTE), ethylene chlorotrifluoroethylene (ECTFE), non-woven polyester, and non-woven polypropylene. Other materials are possible.

The distillate facing surface of the distillation membrane can be darkened or blackened to better absorb the solar radiation. The distillate facing surface can have carbon black particles. The carbon black particles reduce impurities from the water vapor in addition to absorbing solar radiation. The carbon black particles can have a diameter of from 15 nm to 500 nm as long as they do not severely block the pores of membrane. The membrane can be white and painted black. The carbon black particles can be provided in an ink or suitable resin or adhesive, that is also preferably black. Black or dark paints that do not contain carbon black particles can be utilized so long as the coating does not significantly block the pores of the distillation membrane. One of the advantages of this invention over solar stills lies in its higher efficiency in heating and evaporating water and thus the higher distilled water production rate. The carbon black coating of the membrane enhances the evaporation rate by almost 57% than the natural evaporation of water. The focused heating on the capillary structure of feed water within the membrane render this invention more energy efficient in feed water evaporation and distilled water production.

The feed water chamber, distillate chamber, and the condensing channel can be made of any suitable material. An acrylic glass was used to make the prototype. For full-scale devices, other structural materials such as aluminum, steel, fiber reinforced plastic, fiber reinforced composite, HDPE will also work to build the device. The window at the top of the distillate chamber must be made of a transparent or transmissive material which does not release toxic chemicals into distilled water. Examples of suitable materials include clear acrylic, glass, polycarbonate, polyethylene, polypropylene, polyethylene terephthalate, polyvinylchloride, and acrylonitrile butadiene styrene.

A gasket can be provided between edge portions of the feed water facing surface of the membrane and the feed water chamber, and a gasket between edge portions of the distillate facing surface of the membrane and the distillate chamber. The gasket can be made from any suitable sealing material such as tan pure gum rubber, silicone, neoprene, nitrile, tetrafluoroethylene propylene, and fluorosilicone as long as the material does not release toxic chemicals into distilled water.

The membrane can experience significant hydraulic pressure due to the variable pressure head at the feed water inlet as water fills the feed water chamber. The solar distillation device can have a mesh spacer for retaining the membrane in position. The solar distillation device can further include a mesh spacer for restricting the movement and deformation of the distillation membrane.

A sedimentation zone can be provided in the feed water chamber and can include a sump portion for collecting and disposing of sediments. A sediment outlet can be provided and is in communication with the feed water compartment and the sump portion, and is below the feed water inlet. The sediment outlet can have a removable closure or a valve to permit the removal of accumulated sediment.

The device should be maintained in a proper orientation such that the feed water flows into the device and distillate flows out of the device under the influence of gravity. A support stand can be provided for maintaining the feed water inlet above a portion of the feed water compartment, and for maintaining a portion of the distillate compartment above the condensed water outlet, whereby feed water will flow into the feed water compartment under the influence of gravity, and water distillate will condense and flow out through the condensed water outlet under the influence of gravity. A stand can be provided to facilitate maintaining the device in the inclined position. The inclination (θ) of the device can range from 5° to 75°.

Some condensation will occur at the walls of the distillate chamber due to the difference between the ambient temperature and the higher temperature within the distillate chamber. A distillate guider can be provided for collecting condensate from the side portions of the distillate chamber. The distillate guider can be an upwardly facing channel at interior facing sides of the distillate chamber. Other designs are possible. The distillate guider collects condensate of distillate vapor in the distillate compartment and directs the distillate water toward the distillate water outlet.

The solar distillation device can be made by any suitable method. The membrane and gaskets are positioned between the feed water chamber and the distillate chamber. The assembly is secured together. More or fewer pieces can be used to make the device. The feed water chamber and the distillate chamber can be detachably connected to facilitate construction and also cleaning and repair of the solar distillation device. The feed chamber and the distillate chamber can be joined together using nuts and bolts which provide adequate pressure on the membrane and gaskets. Other locking/sealing mechanisms such as toggle latch, toggle bolts, clamps and adhesives can be used instead of nuts and bolts.

Additional features can be provided to facilitate the gathering and focusing of solar radiation. A Fresnel lens such as at the top of the distillate chamber will concentrate the sunlight and increase the production of distilled water significantly. Solar gathering reflectors can be provided to collect and direct light to the light transmissive portion.

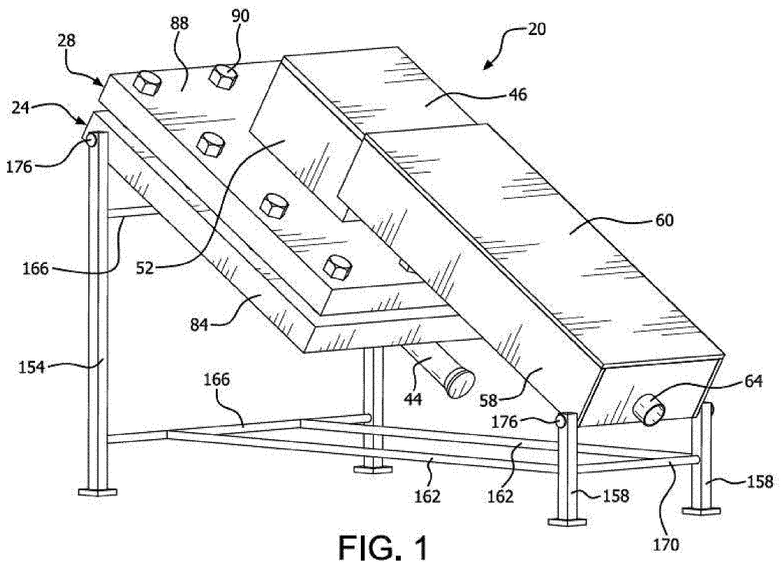

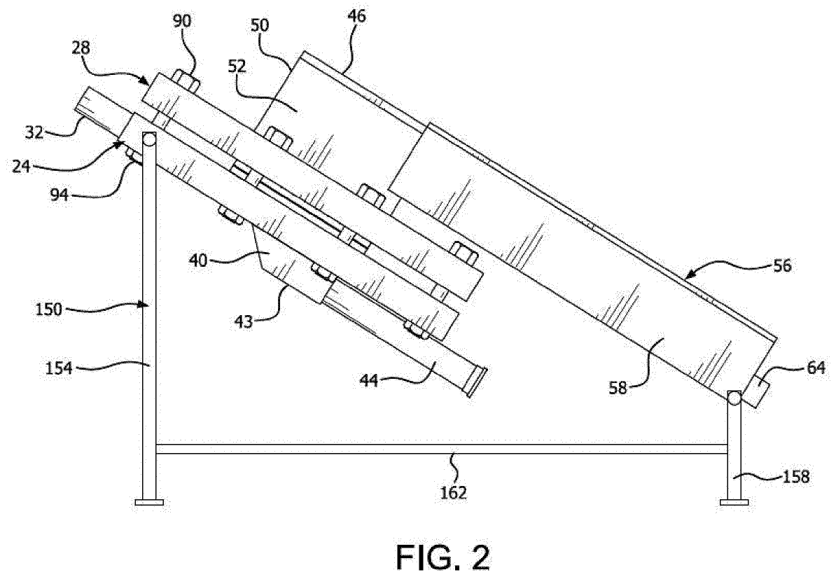

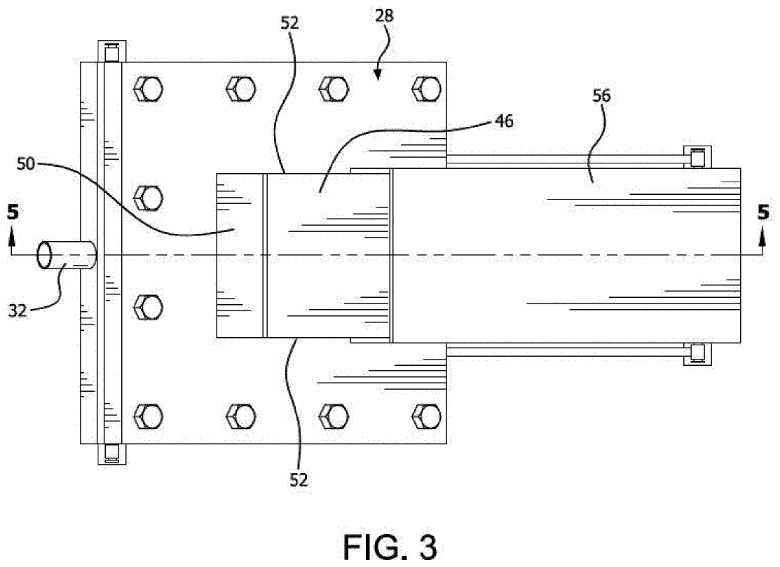

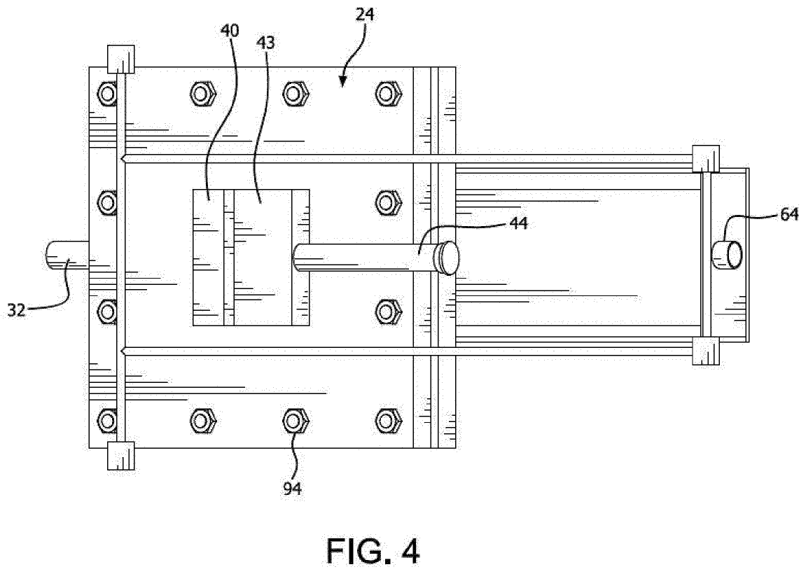

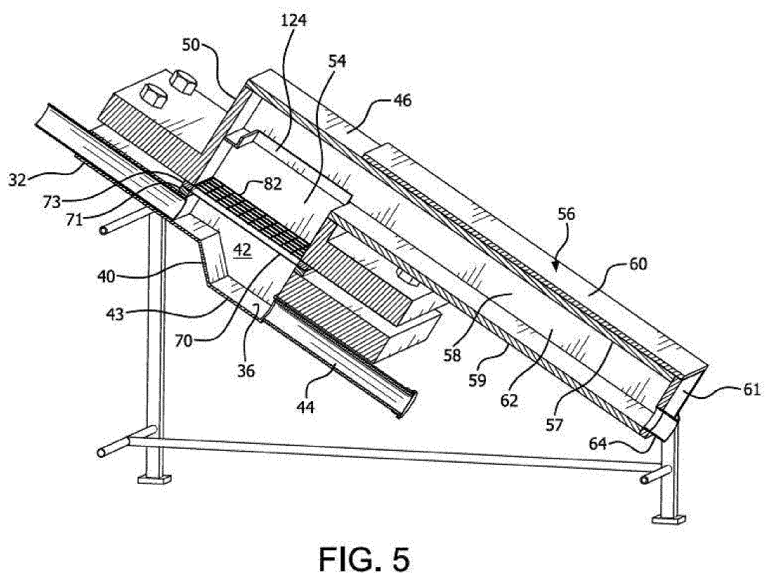

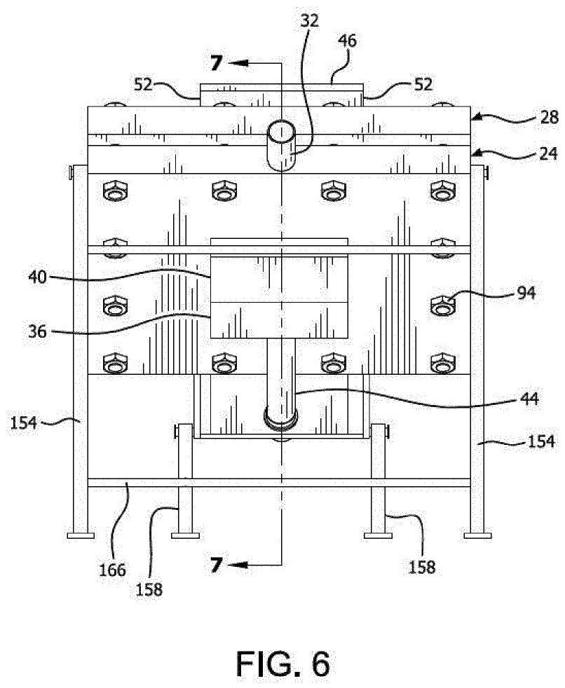

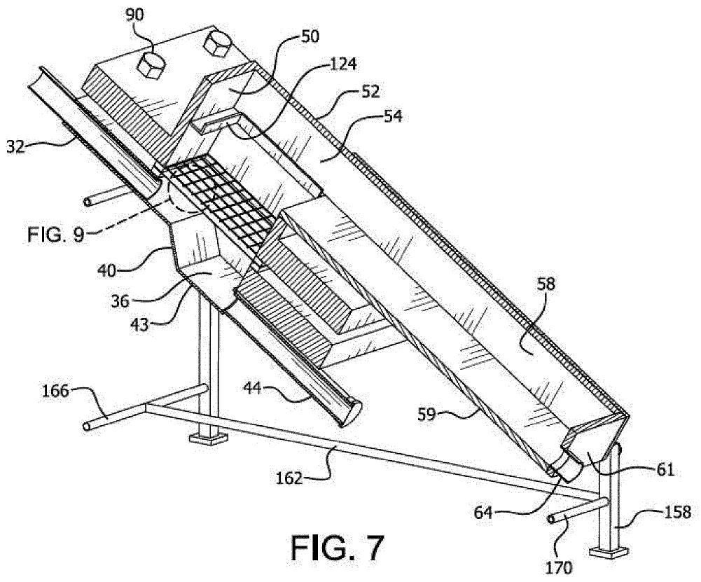

There is shown in FIGS. 1-6 a solar distillation device 20 according to the invention. The device 20 includes a feed water chamber 24 and a distillate chamber 28. The feed water chamber 24 includes a feed water inlet 32 and a feed water compartment 36 having an open interior 42. An angled rear wall 40 can descend to a sump 43 for the collection of sediment from the feed water compartment 36. An outlet 44 can be provided for the removal of the sediment.

The distillate chamber 28 includes light transmissive top 46 and rear wall 50 and sides 52 defining an open interior distillate compartment 54. The distillate compartment 54 can communicate with a condensing chamber 56. The condensing chamber 56 includes top 57, sides 58, bottom 59 and end wall 61 defining an open interior condensing compartment 62. A light reflective or blocking material 60, which can also be thermally insulating, can be provided at the top 57 and sides 58 to reflect light from the condensing channel to provide a relatively lower temperature therein than is in the distillate compartment 54. A condensed water outlet 64 can be provided in end wall 61 and can communicate with a condensed water collection container 68.

A porous distillation membrane 70 is positioned between the feed water chamber 24 and the distillate chamber 28 and separates the open interior 42 of the feed water compartment from the distillate compartment. The membrane 70 can be supported between sealing gasket 71 on the feed water chamber 24 side and the sealing gasket 73 on the distillate compartment 28 side. A screen or mesh spacer 82 can be provided to support the membrane 70 against bowing, stretching or breaking under the influence of water pressure.

The feed water chamber 24 and the distillate chamber 28 can be formed by any suitable means and pieces which are secured together by suitable fastening structure. One such fastening structure shown in the drawings utilizes flange portion 84 on the feed water compartment 24 and flange portion 88 on the distillate compartment 28 which are provided with suitable apertures for receiving bolts 90, which are engaged to nuts 94. Other fastening structure is possible.

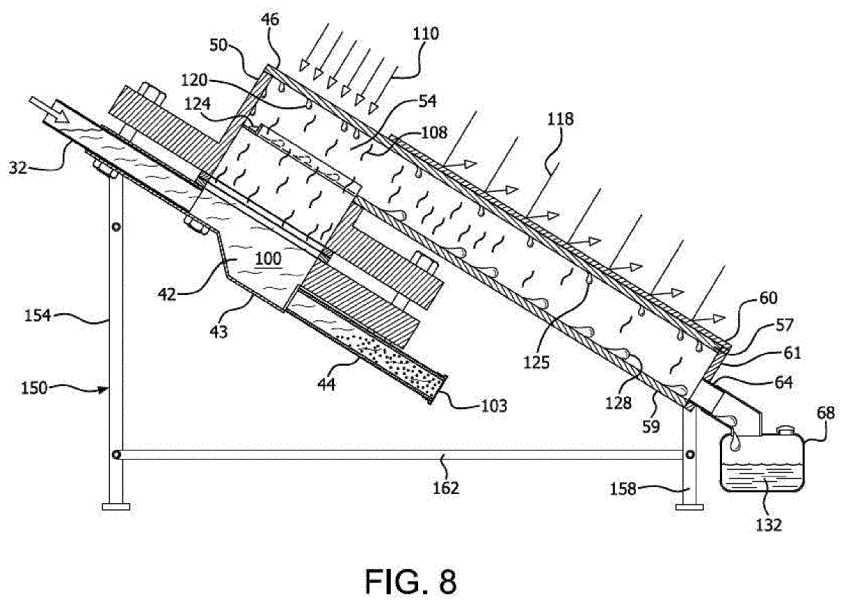

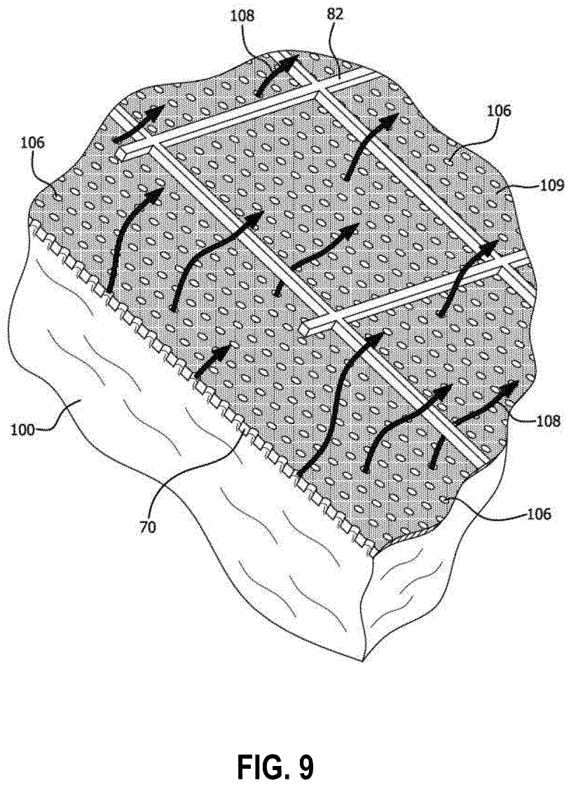

Operation of the device is shown schematically in FIGS. 8-10. Water 100 fills the feed water compartment 42. Water 102 enters the pores 106 of the membrane 70 by hydraulic pressure. The surface tension between the hydrophobic membrane 70 and water 100 prevents water penetration through the membrane. At least a top surface of the membrane is blackened as by paint coating 109. Solar radiation 110 is transmitted through the transmissive top portion 46, rear wall 50 and sides 52, and strikes the membrane 70 and is absorbed by the blackened surface 109. The absorbed heat is communicated to the water 102 in the pores 106, accelerate the evaporation of water 102 and produces water vapor indicated by arrows 108. Sediment 103 from the feed water 100 collects in the sediment outlet 44 and can be removed as necessary.

The water vapor 108 enters the distillate compartment 54. The water vapor 108 condenses into droplets 120 at top 46, rear wall 50 and sidewalls 52 of the distillate chamber 28. A distillate guider 124 can be provided to collect the condensate and direct the condensate toward the condensation portion 56. The distillate guider 124 can include an upwardly facing channel at interior facing sides of the distillate chamber. The distillate guider 124 collects condensate of distillate vapor in the distillate compartment 54 and directs the distillate water toward the condensed water outlet 64. The condensation chamber 56 reflects incoming radiation 118 due to the reflective coating 60. The temperature in the condensation compartment 62 is relatively less than the temperature of the distillate compartment 54 due to the transmission of light through the top 46, rear wall 50 and sides 52, and the heat generated at the membrane 70 and by the water vapor 108. Condensed water droplets collect at the walls of the condensing chamber 56 such as water droplets 125 at the top 57 and water droplets 128 at the bottom 59. The water droplets 125 collect with the droplets 128 and the droplets which are passed to the condensing compartment 62 by the distillate guider 124. Water leaves the condensing chamber 56 through the condensate outlet 64 and water 132 collects in clean water distillate storage container 68.

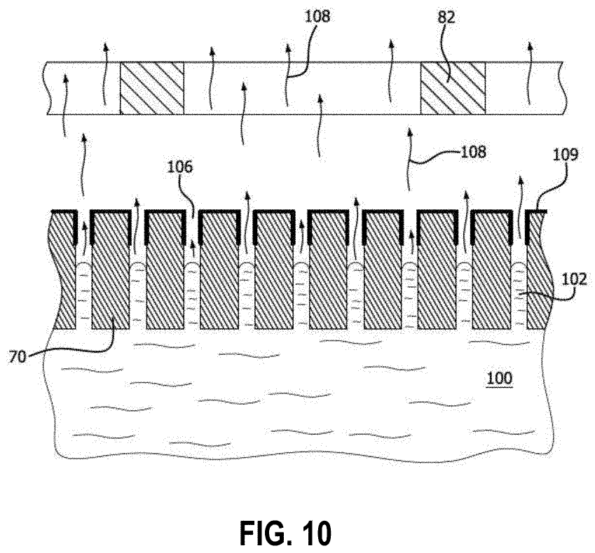

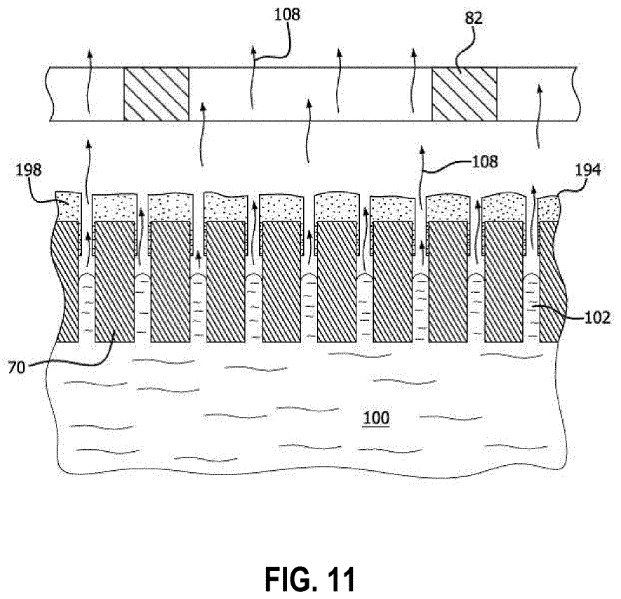

The surface of the porous membrane can be as black as possible to absorb solar radiation and improve efficiency of distillation. The membrane can be made of a black material, but a black material is not necessary. A coating such as the paint 109 as shown in FIG. 10 can be provided. As shown in FIG. 11, a coating 194 can be provided at the surface of the membrane 70 and can have embedded therein carbon black particles 198. The carbon black particles 198 additionally serve to filter and purify water vapor passing through the pores 106.

The solar distillation device should be operated at an incline such that feed water enters the feed water chamber under the influence of gravity, and distillate water vapor condenses as water droplets in the distillate compartment and in the condensing compartment moves to the condensate outlet 64 and to the collection container 68 under the influence of gravity. The solar distillation device 20 can have integral structure for maintaining the desired orientation. Alternatively, a support stand 150 can be provided to maintain the solar distillation device at the appropriate orientation. Such a device can have any suitable design. In the embodiment shown tall vertical supports 154 and short vertical supports 158 are provided for maintaining the solar distillation device 20 at an angle between the tall vertical supports 154 and the short vertical supports 158. Horizontal support 162 and lateral supports 166 and 170 can be provided to secure the support together. Pivotal pin mountings 176 can be provided to secure the solar distillation device 20 to the stand 150.

Solar distillation devices according to the invention were made and tested. A commercially available porous hydrophobic white membrane (PVDF) with one side coated with carbon black particles was placed between the feed water chamber and the distillate chamber. The blackened side of the membrane faced the distillate chamber and sunlight, and functioned as a heat absorber. The white side of membrane faced the feed water chamber, having direct contact with the feed water. The carbon black particles used for coating the distillate side of the membrane had a mean hydrodynamic diameter of 133 nm. Speedball® super black ink was used as the source of the carbon black particles for coating the membrane. The PVDF membrane had a nominal pore size of 0.45 μm and a thickness ranging from 75 μm to 80 μm. The thickness of the coating could not be measured since the carbon black particles did not form any visible layers based on the scanning electron microscopic imaging.

A silicone rubber gasket (2 mm in thickness) was placed between the membrane and the feed water chamber for preventing the leakage of feed water. Another silicone rubber gasket was placed between the membrane and the distillate chamber for preventing the leakage of water vapor from the distillate chamber. A black mesh spacer was placed between the upper gasket and the distillate chamber to restrain the upward deformation of the membrane due to water pressure. This mesh spacer can also be used in between the membrane and the upper gasket.

The distillate chamber was placed in the sun with an inclination. A transparent window was provided at the top of the distillate chamber so that the sunlight could directly pass through and fall on the black side of the membrane. The distillate chamber was connected with a condensing chamber and a condensing compartment. The condensing chamber had a reflective surface reflecting the sunlight and thus provided a cool environment allowing water vapor to condense into distilled water. This condensing chamber is an auxiliary part of the device to facilitate the condensation of the vapor. The device will also work without the condensing compartment. A distillate guider was used for collecting the distilled water drops that could form on the three side walls of distillate chamber and guide the water drops towards the condensing channel. This distillate guider was made of the same material as the distillate chamber.

Solar thermal heating took place on the permeate side (the blackened side) of the membrane rather than the feed side (the white side). The feed water formed capillary structures in the membrane, which was heated efficiently within the membrane without losing too much heat into the bulk feed water. Upon evaporation, the water vapor passed through the carbon black coating. Volatile organic impurities, if any, were absorbed by the carbon black coating and removed from the water vapor. Then, the water vapor entered the distillate chamber and the condensing chamber, and released heat on the acrylic glass wall and condensed into distilled water. Some water vapor was condensed on the walls of the distillate chamber. Those water drops on the side walls of the distillate chamber were guided into the condensing channel with the help of the distillate guider.

The device was placed with an inclination (θ) so that the condensate can get into the clean water tank under the influence of gravity. In addition, the sediments in the feed water were collected in the sedimentation zone and were disposed of periodically through the sediment exit.

The capillary structure the feed water formed within the membrane made the solar thermal heating localized and focused on the feed water within the membrane rather than the bulk feed water beneath the membrane, further enhancing the efficiency of utilizing solar thermal energy. The carbon black coating on the permeate side of membrane not only served as heat absorber but also as strong absorbents for removing volatile organic impurities from the water vapor passing through the carbon black coating.

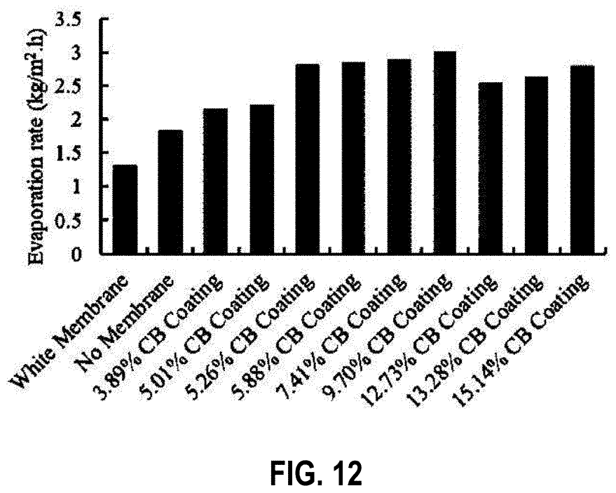

A water quality assessment was performed for the distilled water produced by the invention using seawater, canal water, and wastewater as the feed water. Seawater, canal water, and municipal wastewater were used as the feed water to produce distilled water using this invention. The production rate of distilled water is comparable with that when deionized water is used as the feed water. FIG. 12 is a plot of evaporation rate (kg/m² h) of deionized (DI) water contained in a glass beaker and covered by a white membrane, no membrane, and carbon-black coated membranes with different amounts of carbon-black particles as the coating, under simulated sunlight at an irradiance of 1812 W/m². When canal and wastewater were used instead of DI water, the production rates are reduced by 7.86% and 10.82%, respectively. When seawater is used instead of DI water, the production rate increased by 1.80%.

The quality of the distilled water is shown and compared with the respective feed water in Table 1, 2, and 3. The turbidity, pH, electrical conductivity, and total dissolved solids of distilled water shown in the tables meet the standards set by the National Primary Drinking Water Regulations. In addition, there was no bacteria detected from distilled water in heterotrophic plate count and no protozoa observed in distilled water under an optical microscope. Thus, the distilled water produced by this invention is safe to drink when seawater, canal water, and municipal wastewater are used as the feed water.

Table 1 provides the water quality parameters of the raw seawater and the produced distilled water when seawater was used as the feed water during the initial 4 hours of operation.

TABLE 1

| Measurements | Seawater | | Distilled water | |
|---|---|---|---|---|
| Turbidity | 0.64 | NTU | 0.17 | NTU |
| pH | 8.06 | | 7.87 | |
| Electrical Conductivity (EC) | 53.88 | m/Scm | 0.183 | mScm |
| Chemical Oxygen Demand (COD) | N/A^{††} | | 4.5 | mg/L |
| Total Dissolved Solids (TDS)^{†} | 48510 | mg/L | 101 | mg/L |

^{††}The Chemical Oxygen Demand (COD) of raw seawater cannot be used to represent the concentration of organic impurities due to the significant interference by chloride ions.

Table 2 provides the water quality parameters of the raw canal water and the produced distilled water when canal water was used as the feed water during the initial 4 hours of operation.

TABLE 2

| Measurements | Canal Water | | Distilled water | |
|---|---|---|---|---|
| Turbidity | 4.75 | NTU | 0.16 | NTU |
| pH | 7.67 | | 7.48 | |
| Electrical Conductivity (EC) | 10.43 | m/Scm | 0.106 | mScm |
| Chemical Oxygen Demand (COD) | 70.5 | mg/L | 3 | mg/L |
| Total Dissolved Solids (TDS)^{†} | 6780 | mg/L | 58.5 | mg/L |

Table 3 provides the water quality parameters of the raw wastewater and the produced distilled water when municipal wastewater was used as the feed water during the initial 4 hours of operation.

TABLE 3

| Measurements | Wastewater | | Distilled water | |
|---|---|---|---|---|
| Turbidity | 210 | NTU | 0.24 | NTU |
| pH | 7.31 | | 8.03 | |
| Electrical Conductivity (EC) | 0.899 | m/Scm | 0.515 | mScm |
| Chemical Oxygen Demand (COD) | 452.5 | mg/L | 4.3 | mg/L |
| Total Dissolved Solids (TDS)^{†} | 539 | mg/L | 283 | mg/L |

* All experiments have been conducted in between 22° C. to 25° C.
^{†}The Total Dissolved Solids (TDS) has been calculated from the measured Electrical Conductivity (EC). The relation between them is “TDS (mg/L) = K × Electrical Conductivity (mS/cm)”. The K value ranges from 550 to 900 depending on the value of Electrical Conductivity at 25° C.[7].

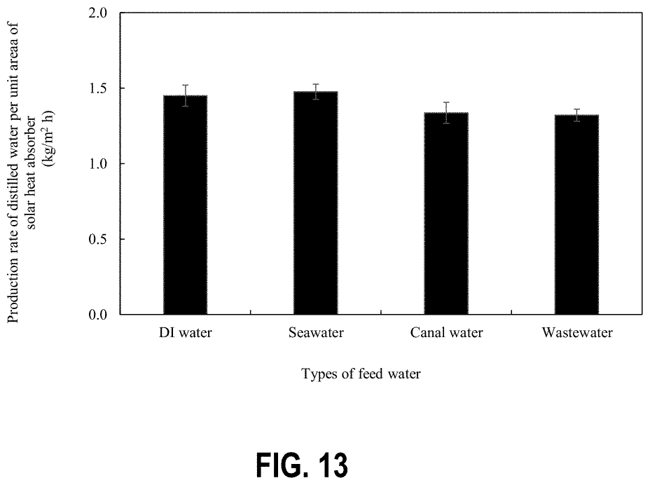

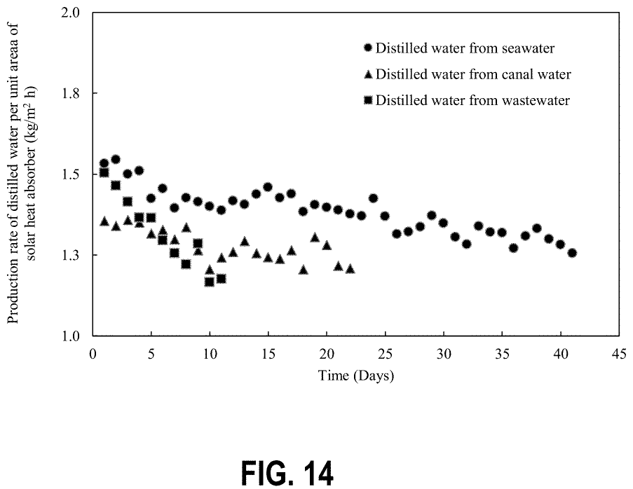

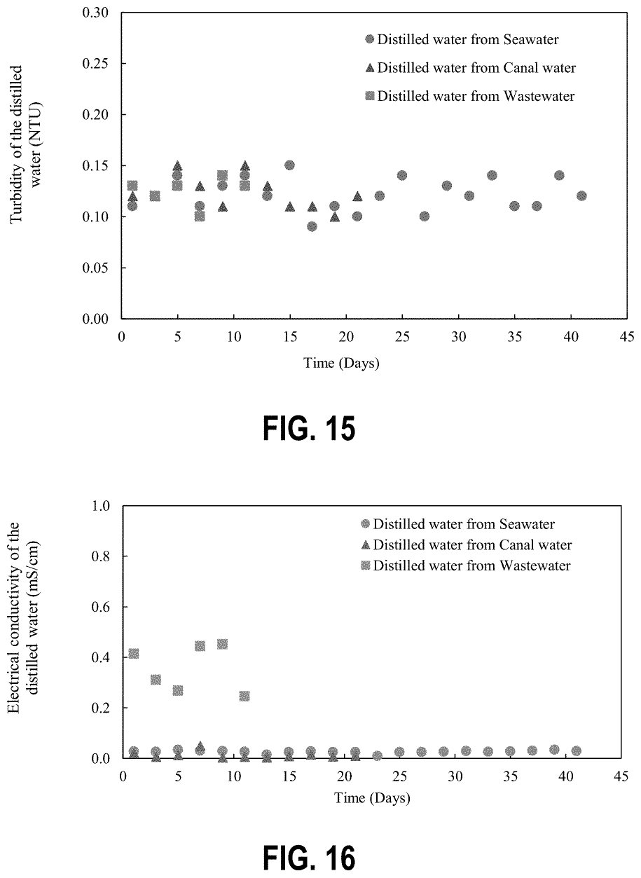

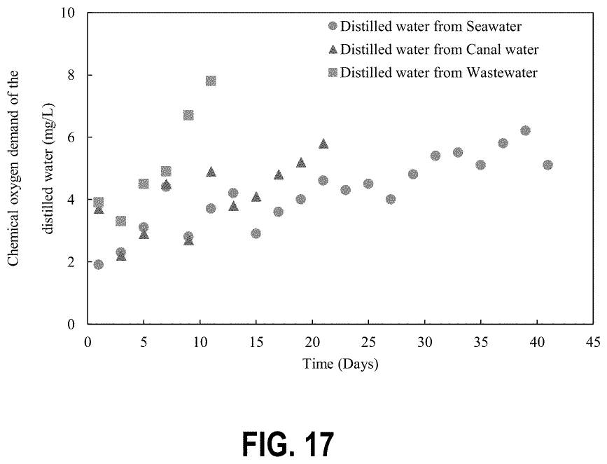

The water quality parameters are plotted in FIGS. 13-17. FIG. 13 is a plot of the production rate of distilled water per unit area of solar heat absorber (kg/m² h) for DI water, seawater, canal water, and wastewater over initial 4 hours of operation. FIG. 14 is a plot of the production rate of distilled water per unit area of solar heat absorber (kg/m² h) vs. time (days) for seawater, canal water, and wastewater. FIG. 15 is a plot of turbidity (NTU) vs. time (days) for the distilled water produced from seawater, canal water, and wastewater. FIG. 16 is a plot of electrical conductivity (mS/cm) vs. time (days) for the distilled water produced from seawater, canal water, and wastewater. FIG. 17 is a plot of chemical oxygen demand (mg/L) vs. time (days) for the distilled water produced from seawater, canal water, and municipal wastewater.

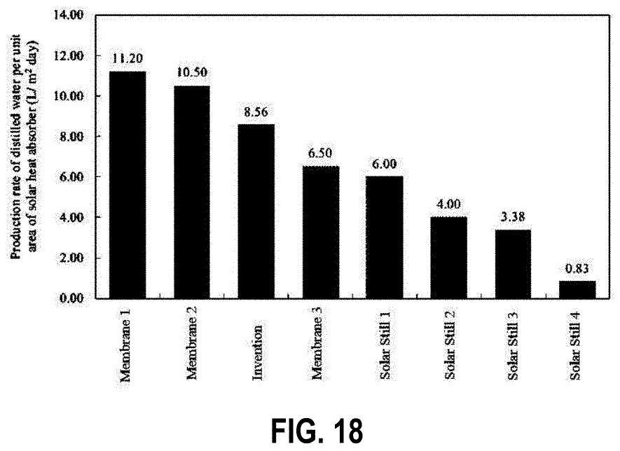

FIG. 18 shows the comparison in production rate of distilled water per unit area of solar heat absorber (L/m² day) under natural sunlight between the miniaturized prototype of this invention with the condensing channel and several existing solar membrane distillation systems. The invention has comparable production rate of distilled water per unit area of solar heat absorber with the existing solar membrane distillation systems even when the capital cost is significantly lower than existing systems and no electricity is used in the invention for circulating the feed water and distilled water in the system. FIG. 18 also shows that the invention provides a production rate of distilled water per unit area of solar heat absorber (L/m² day) that is superior to existing solar stills.

The comparison of production rate of distilled water per unit area of solar heat absorber (L/m² day) between this invention and existing solar stills are presented in FIG. 18. This invention has higher production rate of distilled water per unit area of solar heater absorber compared with the existing solar stills. Thus, this invention would have the smallest footprint compared to the existing solar stills when the same production rate of distilled water is needed. In addition, the carbon black coating on the permeate side of membrane can reduce volatile organic impurities from the steam while the existing solar stills do not have this ability.

The invention can produce potable water from untreated surface water, wastewater, and seawater, using solar thermal energy. Water vapor is evaporated from the feed water within the pores of the carbon black-coated membrane, transported into the distillate chamber, and condensed into distilled water. The invention requires no electricity and has a higher production rate of distilled water per unit area of solar heat absorber than existing solar stills. The invention removed not only suspended particles, microorganisms, and nonvolatile chemical impurities but also most volatile organic impurities from the feed water.

This solar thermal membrane distillation system can be further modified for better performance and efficiency. Changing the shape and materials of condensing channel may improve the distilled water production rate. Also, a feed water reservoir can be integrated with the device as an auxiliary part for more convenient operation. Additionally, a different carbon black material might increase the clean water production rate. As stated earlier, this invention will also work without the condensing channel as well. Moreover, it is possible to scale up the device for greater production of distilled water.

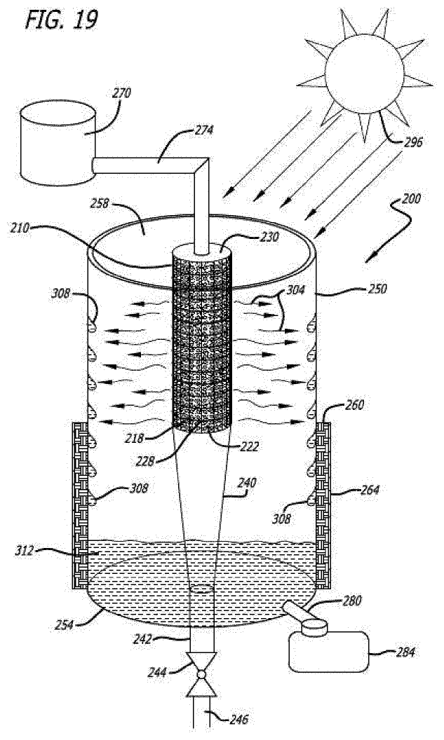

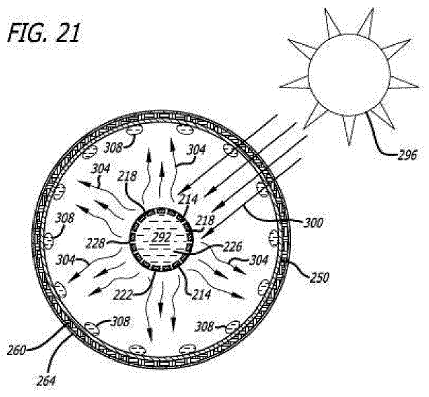

An alternative embodiment of the invention illustrating one such modification is shown in FIGS. 19-21. The solar distillation device 200 includes an enclosed, in any suitable shape and in this case tubular, porous distillation membrane assembly 210. The porous distillation membrane assembly 210 includes a porous membrane 214 having a plurality of pores 218. A black surface portion or coating 222 can be provided on an outside surface of the porous membrane 214 to absorb solar radiation. The membrane and surface coating can be formed of materials as previously described. A supporting mesh 228 can be provided for the tubular membrane assembly 210. The tubular membrane assembly 210 has an open interior 226 which serves as a feed water compartment for retaining unfiltered water 292 next to the membrane 214. The membrane assembly 210 can have a lid 230.

A distillate chamber 250 with an open interior surrounds the tubular membrane assembly 210. The distillate chamber 250 comprises a solar radiation transmissive portion, such that solar radiation can penetrate the distillate chamber and strike the black surface portion or coating 222 of the porous membrane 214. The distillate chamber 250 can include a top 258 which can also comprise a solar radiation transmissive portion. The top 258 can also comprise structure for engaging the tubular membrane assembly, such as a flange or groove into which the top of the membrane assembly 210 can fit and engage. The top 258 can be secured to the distillate chamber 250 by suitable fastening structure such as adhesives, cooperating threads or clamps, and other suitable structure. The distillate chamber 250 can also include a base 254. The distillate chamber 250 can have any suitable shape, such as a cylinder, a cone, a box with straight sides, and the like.

A sediment collection portion 240 abuts the tubular membrane assembly 210. The sediment collection portion can be shaped like a funnel, or can have other shapes. The sediment collection portion 240 collects sediment from the unfiltered water 292. The sediment collection portion 240 can have any suitable shape, such as the funnel shape as shown. A collection conduit 242 can extend from the base 254 and communicate with a valve 244 and exit conduit 246 to remove the sediment when desired.

A thermally insulating material 260 can line a bottom portion of the distillate chamber 250 to block solar radiation. The thermally insulating material 260 keeps portions of the distillate chamber 250 cooler, and facilitates condensation of vapor passing through the tubular membrane assembly 210 into the distillate chamber 250. A surface portion of reflective material 264 can be provided on the thermally insulating material 260 to reflect solar radiation and also facilitate condensation.

Water is supplied to the membrane assembly 210 from a suitable source 270 and a water supply conduit 274. Condensation collecting in the distillate chamber 250 exits through a water exit conduit 280 and can be stored in a suitable storage container 284.

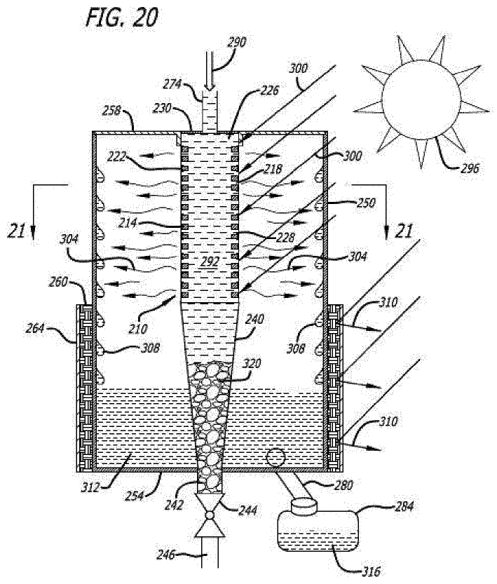

In operation, water is supplied to the open interior 226 from the source 270 through the conduit 274 which can communicate with an opening in the lid 230 or top 258 as shown by arrow 290 (FIG. 20). Radiation from sun 296 in the form of rays 300 strikes the black surface coating 222 of the tubular membrane 214 and, as previously described, heats water 292 in the open interior 226 in the vicinity of the membrane 214, generating vapor 304 which passes through the pores 218 into the distillate chamber 250.

The vapor 304 condenses as droplets 308 on an interior wall of the distillate chamber 250. The reflective material 264 reflects rays 310 of the solar radiation to reduce the temperature of portions of the distillate chamber 250 to facilitate condensation. Accumulated water 312 collects at the base of the distillate chamber 250, and can pass through conduit 280 to container 284 as purified water 316. Sediment 320 collects in the sediment collection portion 240 and can be periodically removed by opening the valve 244.

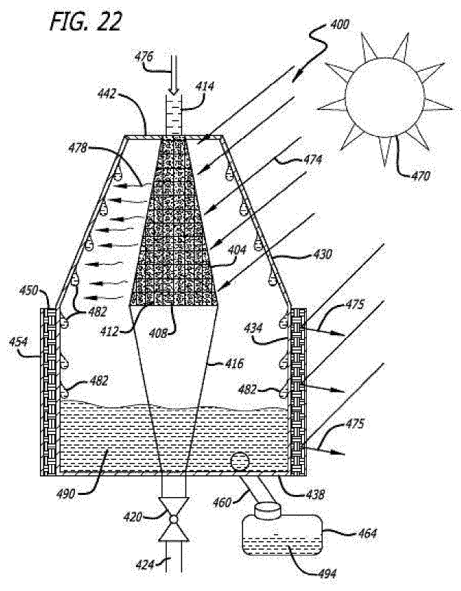

An alternative embodiment of a solar distillation device 400 is shown in FIG. 22. The device 400 includes a membrane assembly 404 in the form of a cone. The membrane assembly 404 includes a porous membrane 408 with a black coating or surface and supporting mesh 412. A sediment collection portion 416 as previously described communicates with the cone membrane assembly 404 for purposes of collecting sediment. A valve 420 and exit conduit 424 can be provided to remove the settlement from the settlement collecting portion 416. A water supply conduit 414 can supply water to the membrane assembly 404. A distillate chamber 430 can also have a portion in the shape of a cone to approximately match the shape of the cone-shaped membrane assembly 404. The distillate chamber 430 can have a bottom 438 and a top 442. A bottom portion 434 of the distillate chamber 430 can be tubular in shape as shown, and if desired the top portion as well. An insulating cover 450 and reflective surface 454 can be provided as previously described. Purified water can be collected through the conduit 460 and container 464.

In operation, sun 470 generates rays 474 which strike the conical membrane assembly 404. The rays 474 will reach the conical shape even when the sun 470 is directly overhead. Although the shape shown is conical, any shape which expands in the downward direction would function similarly. Water enters the membrane assembly 404 through the conduit 414 as shown by arrow 476. Vapor 478 is generated and condenses as water droplets 482 on the walls of the distillate chamber 430. The water droplets collect as accumulated water 490 at the bottom of the distillate chamber 430, and can pass to the container 464 as a purified water product 494.

This invention is capable of producing potable water from untreated surface water, wastewater, and seawater. It does not require any electricity or electrical equipment and solely depends on solar radiation. Since this invention is based on membrane distillation, it has 100% rejection of all the non-volatile solutes, suspending particles, and microorganisms. In addition, the carbon black particles coating on the membrane will remove most volatile organic compounds that evaporate from the feed water into the steam. It is to be noted that the removal of contaminants is primarily due to the evaporation process.

The advantages of this invention over conventional membrane distillation systems include its simplicity in configuration, low capital and maintenance cost, no requirement for electricity, higher efficiency in heating feed water, and better quality of distilled water due to its ability to remove most volatile organic impurities from the steam. The configuration of this invention does not include photovoltaic cells, pumps or heat exchangers for its operation. Thus, it is a very economical in terms of both capital cost and maintenance cost. In addition, it requires no electricity for operation. The integration of a solar thermal absorber (i.e., the carbon black coating) with the membrane renders this invention more efficient in utilizing the solar thermal energy for heating the feed water. It does not have the heat loss due to the transfer of feed water from solar heater to membrane distillation module.

This invention can be embodied in other forms without departing from the spirit or essential attributes thereof. Reference should be made to the following claims to determine the scope of the invention.

We claim:

1. A solar distillation device, comprising a feed water chamber having an open interior feed water compartment and a feed water inlet to the feed water compartment, a distillate chamber having a top and sides and an open interior distillate compartment, and a distillate water condensate outlet in liquid communication with the distillate compartment, the top, the rear wall, and the sides of the distillate chamber comprising a solar radiation transmissive portion, a distillation membrane separating the feed water compartment from the distillate compartment, and having a feed water facing surface and a distillate facing surface, the membrane comprising a porous material comprising a plurality of pores, the transmissive portion allowing solar radiation to pass through the top, the rear wall, and the sides of the distillate chamber, and strike the distillation membrane.

2. The solar distillation device of claim 1, wherein the distillate facing surface of the distillation membrane is black.

3. The solar distillation device of claim 1, wherein the membrane comprises hydrophobic portions to repel liquid water from entering the pores.

4. The solar distillation device of claim 1, further comprising a condensing channel communicating with the distillate compartment.

5. The solar distillation device of claim 1, wherein the feed water chamber and the distillate chamber are detachably connected.

6. The solar distillation device of claim 1, further comprising a gasket between edge portions of the feed water facing surface of the membrane and the feed water chamber, and a gasket between edge portions of the distillate facing surface of the membrane and the distillate chamber.

7. The solar distillation device of claim 1, further comprising a condensing chamber comprising top, side and bottom portions defining an open interior condensing compartment in liquid communication between the distillate compartment and the distillate outlet, the top and side portions of the condensing chamber comprising a solar radiation reflective material.

8. The solar distillation device of claim 1, further comprising a support for maintaining the feed water inlet above a portion of the feed water compartment, and for maintaining a portion of the distillate compartment above the distillate water condensate outlet, whereby feed water will flow into the feed water compartment under the influence of gravity, and water distillate will flow into the condensate outlet under the influence of gravity.

9. The solar distillation device of claim 1, wherein the distillate facing surface of the membrane comprises carbon black particles.

10. The solar distillation device of claim 9, wherein the carbon black particles have a diameter of from 15 nm to 500 nm.

11. The solar distillation device of claim 1, further comprising a sediment outlet in communication with the feed water compartment and below the feed water inlet.

12. The solar distillation device of claim 1, further comprising a mesh for retaining the membrane in position.

13. The solar distillation device of claim 1 further comprising a distillate guider for collecting condensate from the side portions of the distillate chamber, the distillate guider comprising an upwardly facing channel at interior facing sides of the distillate chamber, the distillate guider collecting condensate of distillate vapor in the distillate compartment and directing the distillate water toward the distillate water condensate outlet.

14. The solar distillation device of claim 1, wherein the distillate guider is upwardly facing c-shaped channel.

15. The solar distillation device of claim 1, wherein the distillation membrane pores have a nominal diameter of from 0.02 μm to 200 μm.

16. The solar distillation device of claim 1, wherein the thickness of the distillation membrane is from 5 μm to 500 μm.

17. The solar distillation device of claim 1, wherein the distillation membrane comprises at least one selected from the group consisting of PVDF, PTFE, PP, PE, PCTE, ECTFE, non-woven polyester, and non-woven polypropylene.

18. The solar distillation device of claim 1, further comprising a mesh spacer for restricting the movement and deformation of the distillation membrane.

19. The solar distillation device of claim 1, wherein the distillation membrane is provided as an enclosed distillation membrane assembly with an open interior, and feed water is supplied to the enclosed interior.

20. The solar distillation device of claim 19, wherein the distillation membrane assembly is tubular.

21. The solar distillation device of claim 19, wherein the distillation device membrane assembly is a cone.

22. The solar distillation device of claim 19, wherein the distillation membrane assembly comprises a sediment outlet opening, and further comprising a sediment collection device position to receive sediment from the sediment outlet opening.

23. A method of solar distillation, comprising the steps of:
providing a solar distillation device, comprising a feed water chamber having an open interior feed water compartment and a feed water inlet to the feed water compartment, a distillate chamber having a top and sides and an open interior distillate compartment, and a distillate water condensate outlet in liquid communication with the distillate compartment, the top, the rear wall, and the sides of the distillate chamber comprising a solar radiation transmissive portion, a distillation membrane separating the feed water compartment from the distillate compartment and having a feed water facing surface and a distillate facing surface, the solar radiation transmissive portion allowing solar radiation to pass through the top, the rear wall, and the sides of the distillate chamber and strike the distillation membrane;
connecting a water supply to the feed water inlet so as to cause feed water to flow into the feed water compartment and by hydraulic pressure into pores of the porous membrane, be heated and evaporated, and pass through the distillation membrane into the distillation compartment as water vapor; and,
condensing water vapor into distillate and collecting the water distillate from the distillate water condensate outlet.

24. A method of making a solar distillation device, comprising the steps of:
providing a feed water chamber having an open interior feed water compartment and a feed water inlet to the feed water compartment;
providing a distillate chamber having a top and sides and an open interior distillate compartment, and a distillate water outlet in liquid communication with the distillate compartment, the top, the rear wall, and the sides of the distillate chamber comprising a solar radiation transmissive portion;
providing a distillation membrane separating the open interior of the feed water chamber from the open interior of the distillate chamber and having a feed water facing surface and a distillate facing surface, the solar radiation transmissive portion allowing solar radiation to pass through the top, the rear wall, and the sides of the distillate chamber and strike the distillation membrane;
positioning the distillation membrane between the feed water chamber and the distillate chamber, and connecting the distillate chamber to the feed water chamber.

25. A solar distillation device, comprising:
an enclosed porous distillation membrane assembly comprising a membrane having a plurality of pores and having an open interior providing a feed water compartment, a feed water inlet to the feed water compartment, a sediment outlet, and a black exterior surface portion;
an enclosed distillate chamber having a top and sides and an open interior distillate compartment, the distillation membrane assembly mounted within the distillate chamber, the distillate chamber further comprising a condensate outlet in liquid communication with the open interior of the distillate chamber, portions of the distillate chamber comprising a solar radiation transmissive material, the transmissive portion allowing solar radiation to pass through and strike the distillation membrane;
wherein water in the enclosed feed water compartment will be heated and water vapor will be transmitted through the pores, and wherein the water vapor will condense in the distillate chamber as purified water condensate.

26. The solar distillation device of claim 25, wherein the distillation membrane comprises an interior surface, and portions of the interior surface comprise a hydrophobic material, whereby liquid water will be repelled from the pores and water vapor will pass through the pores of the distillation membrane.

27. The solar distillation device of claim 25, wherein the distillation membrane assembly is tubular.

28. The solar distillation device of claim 25, wherein the distillation membrane assembly is a cone.

29. The solar distillation device of claim 25, wherein the distillation membrane assembly comprises a sediment outlet opening, and further comprising a sediment collection device positioned to receive sediment from the sediment outlet opening.

30. The solar distillation device of claim 29, wherein the sediment collection device is funnel shaped.

31. The solar distillation device of claim 25, wherein the distillate chamber comprises solar reflective portions.

32. The solar distillation device of claim 25, wherein the distillate chamber comprises thermally insulating portions.

33. The solar distillation device of claim 25, wherein the distillate chamber is tubular.

34. The solar distillation device of claim 23, wherein the distillate chamber comprises a cone-shaped portion.
